(19) United States
(12) Patent Application Publication
(10) Pub. No.: US 2009/0279524 A1
(43) Pub. Date: Nov. 12, 2009

(54) METHOD AND APPARATUS FOR REDUCING CONTROL SIGNALING OVERHEAD IN HYBRID WIRELESS NETWORK

(76) Inventors: Yifan Yu, Beijing (CN); Lei Du, Beijing (CN); Yong Bai, Beijing (CN); Lan Chen, Beijing (CN); Akira Yamada, Tokyo (JP); Kei Igarashi, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/464,760

(22) Filed: May 12, 2009

(30) Foreign Application Priority Data
May 12, 2008 (CN) 200810097064.2

(51) Int. Cl. H04W 40/00; H04W 84/12

(52) U.S. Cl. 370/338; 370/328

(57) ABSTRACT

Embodiments of the present invention include a method and apparatus for reducing control signaling overhead in a hybrid wireless network. The method comprises receiving a wireless frame in the hybrid wireless network at a first terminal, and determining whether the received wireless frame is a control frame for a wireless channel reservation; if the received wireless frame is a control frame for the wireless channel reservation, reading by the first terminal a value of Duration field in control frame, and updating a timer for a channel reservation period in the first terminal with the value of Duration field, instead of updating network allocation vector of the first terminal; determining whether the remaining time of the timer for the channel reservation period is longer than the time required for transmitting the data frame or not before transmitting a data frame by the first terminal; and transmitting the data frame directly by the first terminal without transmission of a control frame for the wireless channel reservation if the remaining time is longer than the time required for transmitting the data frame.

### PRIORITY

The present application claims priority to and incorporates by reference the entire contents of Chinese patent application, No. 200810097064.2, filed in China on May 12, 2008.

### BACKGROUND OF THE INVENTION

1. Field of Invention

Embodiments of the present invention relate to a method and apparatus for reducing control signaling overhead in a hybrid wireless network, and in particular to a method and apparatus for improving voice service capacity and quality in a hybrid wireless LAN (WLAN) where data and voice services are incorporated.

2. Description of Prior Art

With the application of voice service to a WLAN, there arises a problem that a large control overhead is required by the WLAN itself, which is a primary factor impacting voice capacity in WLAN.

Generally, WLAN adopts IEEE 802.11 standards to specify the characteristics of MAC (Media Access Control) and physical layer. The protocol for the MAC layer, depending on whether there is any access point participating in communication, defines PCF (Point Coordination Function) used at the time of CFP (Contention Free Period) and DCF (Distributed Coordination Function) used at the time of CP (Contention Period). PCF provides a polling mechanism as a random access protocol technique, in which an access point polls all terminals under its communication coverage to achieve a collision-free transmission. In a more general communication context without any access point, DCF adopts CSMA/CA (Carrier Sense Multiple Access with Collision Avoidance) protocol capable of collision prevention, in which each terminal in the network decides independently whether to access some channels and enters into a Backoff procedure upon access failure for re-accessing the channel. In this way, it is possible to provide a more flexible wireless communication protocol in ad-hoc form.

To fairly and efficiently share wireless channels among individual terminals and to reduce collision between data packets, DCF defines a handshaking procedure based on RTS/CTS/DATA/ACK (Request Transmit Packet/Clear Transmit Packet/Data Packet/Acknowledge Packet) and incorporates NAV (Network Allocation Vector) provided independently at each terminal to further enhance the system performance. In an actual WLAN, however, DCF often simplifies the handshaking procedure into DATA/ACK, while omitting RTS/CTS in the procedure.

FIG. 1 shows a schematic diagram of the operation of the conventional DCF. As shown in FIG. 1, a terminal in the wireless network senses a channel when it acts as a source node having a data packet to be transmitted. If the sensed channel is idle, and the idle period is equal or longer than a DIFS (DCF Interframe Space) as shown in FIG. 1, the terminal immediately transmits a data packet. Otherwise, if the channel is busy, or if the idle period of the channel has not amounted to a DIFS, the terminal senses that the channel is busy and waits for the idle state of the channel. When the idle period becomes equal to a DIFS, the terminal enters into a Backoff process after which the terminal begins to transmit the data packet. The data packet contains TA (Transmitter Address), RA (Receiver Address) and Duration required for completing transmission of subsequent packets. The value of Duration equals to the sum of a time period for transmitting one subsequent ACK packet and a time period for transmitting one SIFS (Short Interframe Space). A receiver terminal, acting as the destination node, will respond with an ACK packet for acknowledgement after it has received the data packet correctly and waited for one SIFS.

A certain terminal in the network will be chosen as the destination receiver node if the terminal has an address matched with the RA contained in the data packet from the source node. The destination receiver terminal will respond to the source node with an ACK packet for acknowledgement after it has received the data packet correctly and waited for one SIFS. Meanwhile, to avoid packet collision among respective terminals, each of non-destination receiver terminals (other terminals) within the communication coverage of the source node, which have received the data packet successfully, will compare the value of Duration in the received data packet with its current value of NAV, update its NAV with a larger value from the comparison result, and agree on that every terminal can initiate a contention for accessing a wireless channel only when its value of NAV is zero. In this way, a virtual reservation of wireless resources is achieved by introducing NAV. This suppresses packet access from a current communication terminal to other terminals within its coverage, thereby ensuring a collision-free transmission of data packet to some extent.

Since the IEEE802.11 standards are designed originally for transmission of Best-effort data in a WLAN, it is difficult for such standards to guarantee service quality requirements corresponding to priorities of different services, such as voice, video, or data. In other words, according to the IEEE802.11 standards, it is impossible to effectively guarantee the quality for a higher priority, such as real-time service for voice or video in the current WLAN.

In view of the above problem, the IEEE802.11 standards extend the capabilities of DCF by an access scheme called “EDCA” (Enhanced Distributed Coordination Access”) in which four access types are specified, with each type corresponding to one class of data. For each access type, three parameters are configured: CWmin representing the minimum contention window, CWmax representing the maximum contention window, and AIFS representing Arbitration Interframe Space.

In the application of DCF, a node having data to be transmitted has to wait for an idle state of media for transmission of its data.

FIG. 2 shows a schematic diagram of the operation of the conventional EDCF according to the standard 802.11e. As shown in FIG. 2, a transmitter having data to be transmitted is waiting for an extra time period, the length of which depends on the type of the data to be transmitted. AIFS value set for the access type of the data defines the extra waiting time period.

After the previous standards 802.11, the IEEE introduced the standard 802.11g, which is a supplement to the existing standards 802.11a and 802.11b. An 802.11g device can be seamlessly back-compatible with any of current mainstream devices of the standard 802.11b, while providing a high transmission rate of 54 Mbps as defined in 802.11a. In this way, it is possible to secure return on realized investment, reduce the cost of device updating and maintain sustainability of technology and market, while user demands can be better fulfilled.

In current 802.11b/g hybrid WLAN, the standard 802.11g introduces a protection mechanism of CTS-to-self frame for coordination control between 802.11b device and 802.11g device and for compatibility between terminals of different physical structures, considering that the 802.11b devices and the 802.11g devices are different in terms of physical receiver structure. The essence of CTS-to-self frame is an identifiable control frame for wireless channel reservation transmitted from the 802.11g devices. The 802.11b devices use the CTS-to-self frame to reserve a channel for subsequent data transmission. The CTS-to-self frame is actually a control frame for wireless channel reservation. Unfortunately, a serious degradation will happen to voice capacity in the network due to the introduction of CTS-to-self frame.

FIG. 3 shows a schematic diagram of control mechanism for adding a control frame for wireless channel reservation, i.e., CTS-to-self frame, into a hybrid WLAN. As shown in FIG. 3, it is supposed that terminals A and C are 802.11g devices, and terminal B is an 802.11b device. When an 802.11g station, for example, terminal A, has data to be transmitted, it first transmits a CTS-to-self frame to update NAV values of other stations and prepare for channel occupation. The CTS-to-self frame is sent out in a format applicable any 802.11b device. Also, the Duration field in the CTS-to-self frame specifies the time period of channel reservation. In general, Duration is equal to “a”, which denotes the total time required for the single data exchange initiated by the 802.11g device. After an SIFS following the transmission of the CTS-to-self frame, the terminal A immediately transmits data packets (Duration is equal to “b”, which denotes the time required for transmitting the data packets). In FIG. 3, the terminals B and C adjacent to the terminal A can receive the CTS-to-self frame transmitted by the terminal A. The 802.11b device, terminal B, can receive only the CTS-to-self frame. After reception of the CTS-to-self frame, the terminal B sets its NAV value as “a” and enters into a Backoff state for the purpose of channel reservation for the terminal A. That is, the terminal B will not attempt any channel access within the period of the Duration. For the 802.11g device, terminal C, it can receive not only the CTS-to-self frame but also the data frames transmitted by the terminal A. According to the specification of the standard 802.11g, the NAV value of the terminal C is also updated with the larger value resulted from the comparison between Duration=a and its own NAV. Accordingly, the terminal C updates its NAV value with a upon reception of the CTS-to-self frame.

After completion of data transmission from the terminal A, the terminal B, if it has data to be transmitted, can directly transmit its data without the first transmission of a CTS-to-self frame since the 802.11g device accepts the format of physical signal from the terminal B. On the other hand, if the 802.11g device, terminal C, has data to be transmitted, it has to first transmit a CTS-to-self frame in the same way as the operation flow of the terminal A.

The protection mechanism of CTS-to-self frame in the standard 802.11g can bring forth certain decrease in network throughput, which refers to the amount of information successfully transmitted over channels of a network in a unit time. For a hybrid network, the protection mechanism introduces increased network overhead and decreased throughput for 802.11g devices.

The network overhead due to the protection mechanism in the standard 802.11g will cause severe degradation in capacity and quality of voice service when voice service is supported by the 802.11b/g hybrid WLAN. At present, there are still a large number of 802.11b devices operating in the WLAN. Consideration has to be given to the issue of compatibility with these existing 802.11b devices during the construction of 802.11g network. Therefore, the 802.11g devices in such hybrid network must adopt the above protection mechanism. This 802.11g protection mechanism requires that all devices transmit their protection control signaling in a CCK modulation mode, and the 802.11g devices must first transmit a CTS-to-self frame for data transmission protection each time one data frame is transmitted. Consequently, a great amount of bandwidth on channels is occupied by transmission of control signaling having nothing to do with actual service content. Statistic data has shown that, in the current 802.11b/g hybrid WLAN, the signaling overhead due to the protection mechanism may amount up to 70% at the time of voice service transmission. In other words, the time for transmitting control signaling is much more than that for transmitting actual service in the network.

As observed in some study and research activities, even if any 802.11b device does not participate in channel contention in the network, the 802.11g WLAN having the protection mechanism may support calling paths of bidirectional voice communication 70% lower in number than those in the 802.11g WLAN having no protection mechanism.

Some methods for improvement have been proposed to address the problem of excessive control overhead in the current 802.11b/g hybrid WLAN. These methods, however, continue to have disadvantages. First, each of the methods requires the network should have the function of PCF, while most of the existing commercial devices cannot support this function.

This reduces usability of the above methods in practical applications. Next, the methods require a great modification on 802.11g access point (AP) that has been put into operation. Such modification will lead to high cost, not good for a rapid deployment.

### SUMMARY OF THE INVENTION

Embodiments of the present invention is to provide a method and apparatus for reducing control signaling overhead in a hybrid wireless network, which can increase capacity of voice service in an 802.11b/g hybrid WLAN by reducing overhead from wireless channel reservation control frames, i.e., CTS-to-self frames.

According to an aspect of the present invention, a method for reducing control signaling overhead in a hybrid wireless network is provided. The method comprises: at a first terminal, receiving a wireless frame in the hybrid wireless network, and determining whether the received wireless frame is a control frame for wireless channel reservation, CTS-to-self frame; if the received wireless frame is a CTS-to-self frame, reading by the first terminal a value of Duration field in the CTS-to-self frame, and updating a timer for a channel reservation period in the first terminal with the value of Duration field, without updating of a network allocation vector of the first terminal; before transmitting a data frame by the first terminal, determining whether the remaining time of the timer for the channel reservation period is more than the time required for transmitting the data frame; transmitting the data frame directly by the first terminal without transmission of CTS-to-self frame if the remaining time is more than the time required for transmitting the data frame.

According to another aspect of the present invention, an apparatus for reducing control signaling overhead in a hybrid wireless network is provided. The apparatus comprises a transmitter to determine the type of a frame to be transmitted and set a value of Duration field and associated type field according to the type of the frame and the quality condition of service in the wireless network; a frame type identifying device to determine the type of a received frame; a CTS-to-self frame processing device having a timer for the channel reservation period and to receive the frame type provided from the frame type identifying device to update the timer for the channel reservation period with the value of Duration field if the received frame is a CTS-to-self frame, without updating of a network allocation vector of the transmitter; and a receiver to receive data and CTS-to-self frames transmitted by the transmitter, and update the network allocation vector according to the type of the received frame and the quality condition of service in the wireless network.

The method and apparatus of the present invention introduces the timer for channel reservation period. The first terminal applied in the first wireless network (e.g., 802.11g wireless network), such as a 802.11g terminal or device, can set the value of Duration field in the CTS-to-self frame according to the payload condition of voice service in the network. The set value is larger than the current value specified in the conventional standard.

Further, after receiving the CTS-to-self frame, the first terminal in the first wireless network may update its own timer for channel reservation period so as to control the transmission of CTS-to-self frame, instead of updating its NAV value with the value of Duration field in the CTS-to-self frame. The first terminal also determines the payload condition of voice service in the network by sensing data frames from its adjacent nodes.

According to the present invention, an 802.11g node (the first terminal) can provide reservation protection for any other 802.11g node by setting the value of Duration field in the CTS-to-self frame to a larger value so that the other 802.11g node does not have to frequently transmit a CTS-to-self frame. It is thus possible to reduce control overhead in the network and enhance the network performance.

### BRIEF DESCRIPTION OF THE DRAWINGS

The above embodiments, advantages and features of the present invention will be apparent from the following detailed description on the preferred embodiments taken conjunction with the drawings in which:

FIG. 1 shows a schematic diagram of the operation of the conventional DCF;

FIG. 2 shows a schematic diagram of the operation of the conventional EDCF;

FIG. 3 shows a schematic diagram of control mechanism for adding CTS-to-self frame into a hybrid WLAN;

FIG. 4 is a schematic diagram of a hybrid wireless network to which the present invention is applied;

FIG. 5 is a block diagram of an apparatus for reducing control signaling overhead in the hybrid wireless network according to an embodiment of the present invention;

FIG. 6 is a flowchart showing the processing of a terminal in the hybrid WLAN receiving a CTS-to-self frame according to an embodiment of the present invention; and

FIG. 7 is a flowchart showing the processing of a terminal in the hybrid WLAN transmitting a CTS-to-self frame according to an embodiment of the present invention.

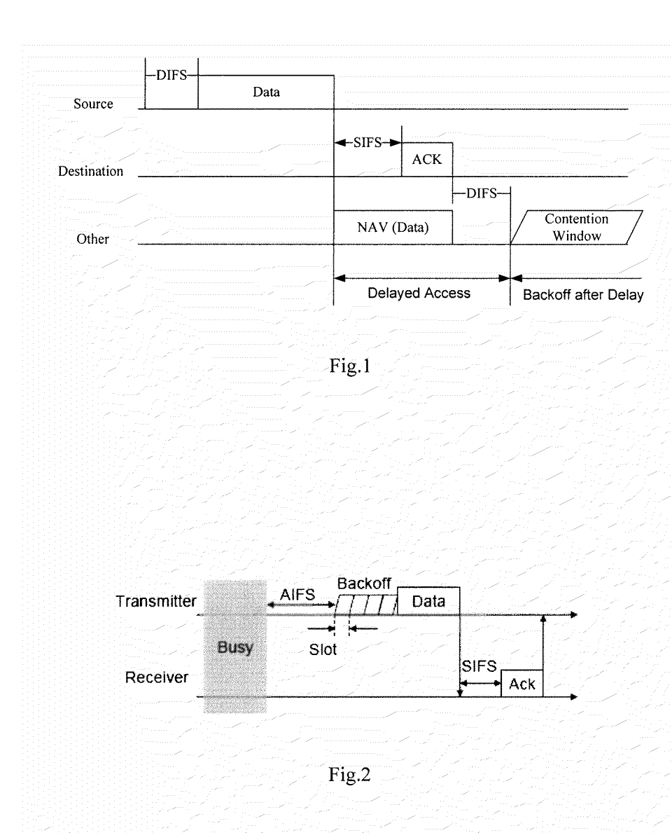

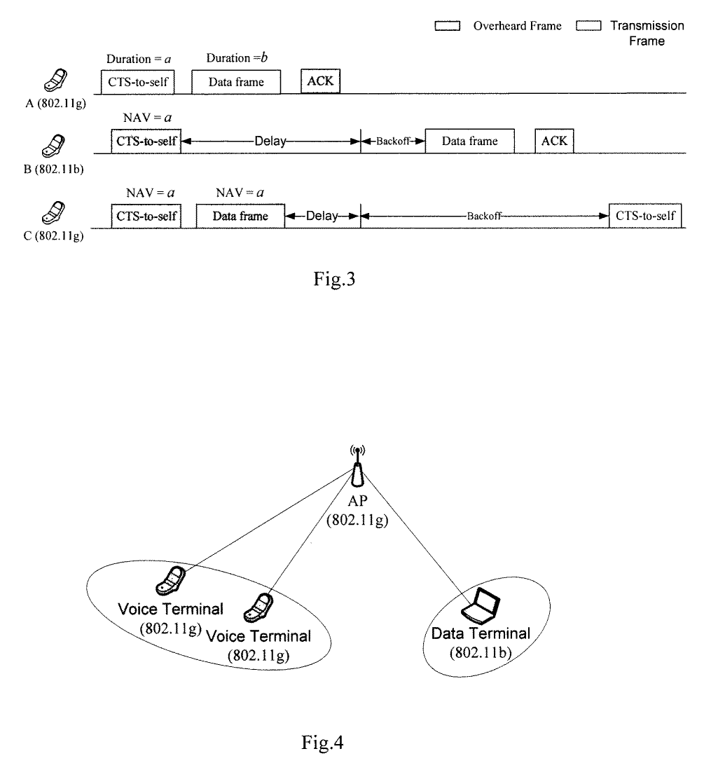

### DETAILED DESCRIPTION OF PREFERRED EMBODIMENTS

Now, a detailed description will be given to the embodiments of the present invention with reference to the figures. In the description, any element or function unnecessary to the description of the present invention will be omitted, in order not to obscure the present invention.

The present invention is illustrated by referring to the figures.

FIG. 4 is a schematic diagram of a hybrid wireless network to which the present invention is applied. In this embodiment, the method and apparatus of the present invention are explained by taking as example a hybrid wireless local area network (WLAN) comprising a WLAN with the 802.11g standard (also referred to as the first WLAN or the first wireless network) and a WLAN with the 802.11b standard (also referred to as the second WLAN or the second wireless network). It should be noted that the present invention is not limited to this example and may also be applied to any other hybrid wireless network with any other standards.

As shown in FIG. 4, it is shown that, in the 802.11b/g hybrid WLAN, there are in total one access point (AP), M 802.11g voice terminals (also referred to as the first terminals or 802.11g terminals or nodes), and N 802.11b data terminals (also referred to as the second terminals or 802.11b terminal or nodes). The AP supports the 802.11g standard. That is, the AP is also an 802.11g node. According to one embodiment the present invention, a timer for the channel reservation period is additionally provided in these network terminals.

In one embodiment of the present invention, the basic random access control mechanism of DCF or EDCA is still adopted in the WLAN, and the channel reservation period timer is used to implement channel reservation through a control frame for wireless channel reservation. In the DCF or EDCA control mechanism, the CTS-to-self frame defined in the current standards can be used as the control frame for wireless channel reservation for the purpose of channel reservation. Now, the operation of the present invention will be described by taking as an example the CTS-to-self frame defined in the current standards. It should be noted that the present invention is not limited to this example and can also use any other frame as the control frame for wireless channel reservation.

After receiving a control frame for wireless channel reservation, i.e., CTS-to-self frame, a 802.11g node will update a channel reservation period timer with the value of Duration field in the frame, instead of its own network allocation vector (NAV). The 802.11g node determines, based on the timer, whether a CTS-to-self frame should be transmitted for the purpose of protection before it actually transmits any data frame.

Specifically, after receiving the CTS-to-self frame transmitted from another node in the hybrid network, the 802.11g node reads the value contained in Duration field of the CTS-to-self frame, and updates the timer channel reservation period maintained by itself with the value. The NAV of the 802.11g node is unchanged. In other words, the 802.11g node does not update its NAV with the value of contained in Duration field of the received CTS-to-self frame. On the contrary, for an 802.11b node, it will update its NAV after reception of a CTS-to-self frame, as specified in the conventional standards. If an 802.11g node, which is not the destination node of the transmitted CTS-to-self frame, needs to transmit data to the AP, the 802.11g node will first read the timing value of the channel reservation period timer maintained by itself. If the value is not less than the time required for completing the current data transmission, the 802.11g node may directly transmit a data frame by effectively using the remaining part of the reservation period, with no need of transmitting a CTS-to-self frame beforehand for protecting this data transmission. Otherwise, if the timing value read by the 802.11g node is less than the time required for completing the current data transmission, the 802.11g node will have to transmit a CTS-to-self frame before the actual transmission of a data frame.

In addition, the 802.11g node will set the value of Duration field according to the current voice service payload condition in the network, before transmitting the CTS-to-self frame. In the present invention, the value of Duration field set by the 802.11g node is greater than the time required for completing the current data transmission. That is, according to one embodiment of the present invention, the value of Duration field in the CTS-to-self frame is greater than the value defined in the conventional standards.

FIG. 5 is a block diagram of an apparatus for reducing control signaling overhead in the hybrid wireless network according to an embodiment of the present invention. Among the terminal devices in the present invention, only 802.11g nodes are modified, while 802.11b nodes keep unchanged.

As shown in FIG. 5, a mobile terminal apparatus of the present invention comprises a transmitter 100, a receiver 200, CTS-to-self frame processing device 300, and frame type identifying device 400. The transmitter 100 comprises transmitting storage device 101, channel accessing device 102 and transmitting device 103. The receiver 200 comprises channel sensing device 201, receiving device 202 and reception processing device 203.

The terminal apparatus according to one embodiment of the present invention may also utilize the basic random access control mechanism of DCF or EDCA. Before transmitting a data frame, a transmitter terminal first determines the type of the data frame. Then, it configures a corresponding value of Duration and the associated type field according to the type of the frame to be transmitted and the quality condition of service of this type in the wireless network.

More specifically, the transmitting storage device 101 in the transmitter 100 stores data packets sent from a higher layer. When a data packet to be transmitted arrives at the transmitting storage device 101, the device 101 first determines the type of the packet. Then, using a corresponding scheme, the transmitting storage device 101 encapsulates the data packet into a data frame (DATA frame) and provides it to the channel accessing device 102, which determines whether the transmitter may access a channel. As an example, the channel accessing device 102 uses CSMA/CA protocol to determine whether the transmitter is allowed currently to access a channel according to the specification of 802.11 DCF. If the channel accessing device 102 indicates the condition of channel access is satisfied, the transmitting device 103 will transmit the DATA frame.

On the other hand, when the mobile terminal apparatus receives the DATA frame from other nodes in the wireless node, the reception processing device 203 indicates successful reception of the DATA frame. When the receiver address (RA) field in the DATA frame matches the address of the mobile terminal, an ACK frame is transmitted.

The channel sensing device 201 included in the receiver 200 senses a channel in the wireless network when the mobile terminal does not transmit any data packet. If it senses a busy channel, the receiving device 202 is activated to prepare for data receiving.

The receiving device 202 receives data from a wireless channel and feeds the received data to the reception processing device 203 for a further determination. The reception processing device 203 determines whether the data packet has been received successfully as well as the type of the received data packet. The reception processing device 203 also instructs the next operations based on its processing result. Specifically, if the reception processing device 203 indicates a successful reception of a DATA packet, and the address in the RA field of the DATA packet matches the address of the mobile terminal, the transmitting device 103 is initiated to prepare for transmitting an ACK packet. If the reception processing device 203 indicates a successful reception of the DATA packet, and the address in the RA field of the DATA packet does not match the address of the mobile terminal, the type field and Duration field of the DATA packet are passed to the frame type identifying device 400. If the reception processing device 203 indicates a successful reception of the ACK packet, and the address in the RA field of the ACK packet matches the address of the mobile terminal, it is detected whether the value of Duration field in the ACK packet is zero. A Duration field value of 0 indicates the completion of transmission. Otherwise, if the value is not 0, the transmitting device 103 is initiated to prepare for transmitting subsequent data packet. If the reception processing device 203 indicates a successful reception of the ACK packet, and the address in the RA field of the ACK packet does not match the address of the mobile terminal, the Duration field of the ACK packet is passed to the frame type identifying device 400.

The frame type identifying device 400 identifies the frame type provided from the reception processing device 203, and provides the frame to the CTS-to-self frame processing device 300 for further processing if the received frame is a CTS-to-self frame. Otherwise, the processing is performed according to the conventional 802.11g standard if the received frame is one of any other types.

The CTS-to-self frame processing device 300 receives the value of Duration field in the CTS-to-self frame provided from the frame type identifying device 400. A timer for channel reservation period is provided in the CTS-to-self frame processing device 300, which updates the timer with the value of Duration field in the CTS-to-self frame and controls the transmission of a CTS-to-self frame based on the timing of the timer. It should be noted that the 802.11g node will not update its NAV as defined in the conventional standards.

According to one embodiment of the present invention, the value configured for the Duration field in the CTS-to-self frame is set much greater than the time required for completing a single data transmission by the 802.11g node. It should be noted that the set value of Duration field in the CTS-to-self frame is equal to the time required for completing only a single data transmission according to the conventional 802.11g standard.

According to one embodiment of the present invention, the 802.11g will transmit a CTS-to-self frame to reserve a channel when it is about to occupy a channel for data transmission. The channel reservation period for the 802.11g node is longer than the time required for completing a data exchange by the same node. In this case, each of the 802.11b nodes within the communication coverage of the 802.11g node reads the value of Duration field in the CTS-to-self frame after receiving the frame. Each 802.11b node updates its own NAV value with the read value of Duration field, which is a greater value. Thus, the 802.11b nodes can back off for a longer time period in which they do not attempt the act of channel access. For each of other 802.11g nodes in the network adjacent to the 802.11g node transmitting the CTS-to-self frame, it does not update its own NAV value with the value of Duration field after receiving the CTS-to-self frame. Instead, the 802.11g node ignores the value of Duration field, and updates its NAV value with the value of Duration field (e.g., duration=b as mentioned previously) in the data frame following the CTS-to-self frame. Accordingly, the Backoff period of each 802.11g node is much shorter than that of each 802.11b node, and there is a time difference between the Backoff periods of the two types of nodes. During this time difference, each of the other 802.11g nodes in the hybrid network can transmit a data frame directly without a beforehand transmission of a CTS-to-self frame. In this way, the network overhead for control frame can be reduced.

In addition, each of the other 802.11g nodes in the hybrid network updates its timer for channel reservation period with the value of Duration field in the CTS-to-self frame. The 802.11g node compares the remaining part of the timer with the time required for transmitting a data frame when it needs to transmit the data frame. If the remaining time of the timer is longer than the required time, the 802.11g node transmits the data frame immediately, with no need of transmitting a CTS-to-self frame. If the remaining time of the timer is not longer than the required time, the 802.11g node has to first transmit a CTS-to-self frame and then transmit the data frame, as defined in the conventional standards.

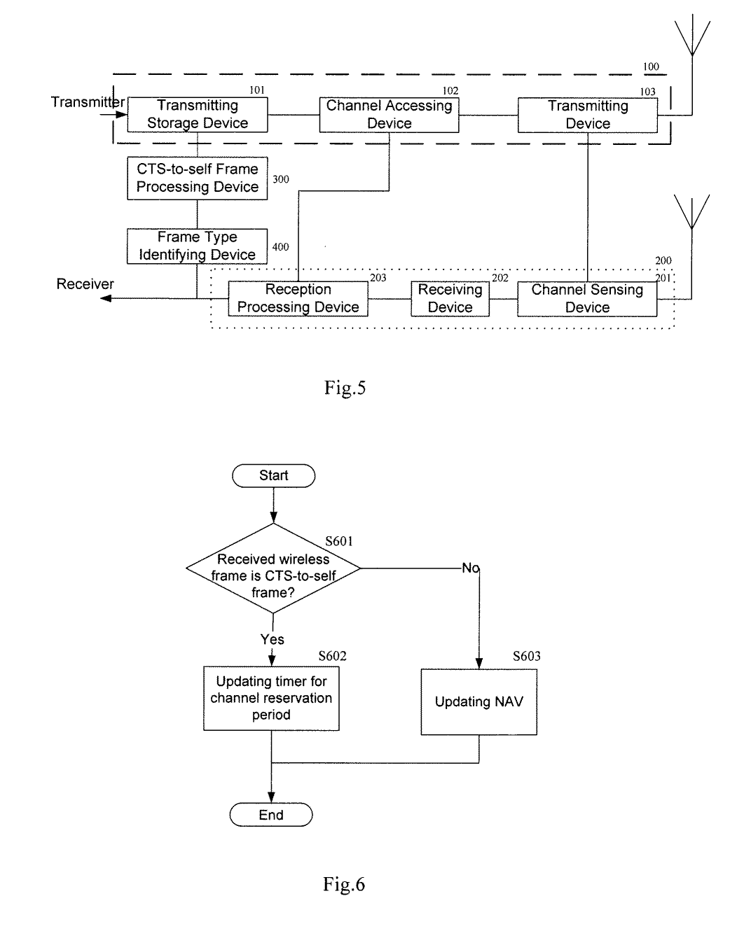

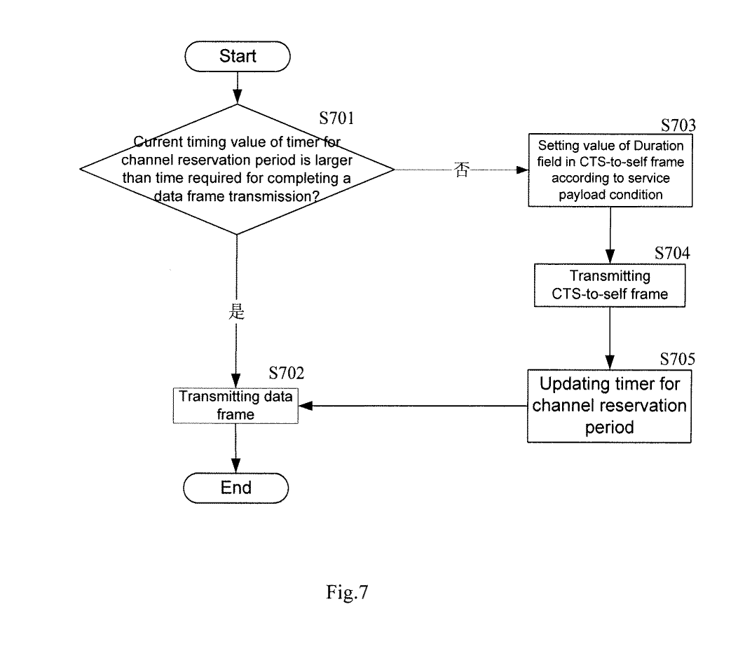

Now, a processing flow of transmitting and receiving a CTS-to-self frame by a terminal in the hybrid WLAN will be described with reference to FIGS. 6 and 7.

FIG. 6 is a flowchart showing the processing of a terminal in the hybrid WLAN receiving a CTS-to-self frame according to an embodiment of the present invention. As shown in FIG. 6, at Step S601, the 802.11g node in the hybrid WLAN, which receives a wireless frame, determines whether the wireless frame is a CTS-to-self frame or not. If the wireless frame is a CTS-to-self frame, the flow proceeds to Step S602, where the 802.11g node updates its timer for channel reservation period, other than its NAV value, with the value of Duration field in the received CTS-to-self frame. In other words, the NAV value of the 802.11g node keeps unchanged. The timer for channel reservation period may be updated with the following equation (1).

New_Counter_Value=MAX(Cur_Duration_Value,Cur_Counter_Value) (1)

where New_Counter_Value represents the updated value of the timer for channel reservation period, Cur_Duration_Value represents the value of Duration field in the received CTS-to-self frame, and Cur_Counter_Value represents the current timing value of the timer. The timer can count time in unit of microsecond, for example, in a time-counting scheme similar to NAV specified in the conventional 802.11g standard, i.e., subtracting a value corresponding to a fixed time interval from the count of the timer every time the fixed interval elapses. For example, after being updated, the timer subtracts a value of 10 from the current timing value when the time period of 10 ms elapses.

If the received wireless frame is not a CTS-to-self frame at Step S601, the flow proceeds to Step S603 where the 802.11g node updates its NAV value with the value of Duration field in the wireless frame as defined in the conventional 802.11g standard so that the node can enter into the Backoff state when another node is transmitting a data frame.

For each of the 802.11b nodes in the hybrid WLAN, it will update its NAV value with the value of Duration field in the CTS-to-self frame after reception of the frame in order to enter into the Backoff state when an 802.11g node is transmitting a data frame.

FIG. 7 is a flowchart showing the processing of a terminal in the hybrid WLAN transmitting a CTS-to-self frame according to an embodiment of the present invention. As shown in FIG. 7, at Step S701, before transmitting a data frame, the 802.11g node in the hybrid WLAN first reads the current timing value (i.e. remaining time) of the timer for channel reservation period provided in the CTS-to-self frame processing device 300, and determines whether the read timing value is more than the time required for transmitting the data frame. If it is determined at Step S701 that the timing value is greater than the time required for completing the data frame transmission by the 802.11g node, the flow proceeds to Step S702. At Step S702, the 802.11g node transmits the data frame immediately. Otherwise, if it is determined at Step S701 that the timing value is not greater than the time required for completing the data frame transmission by the 802.11g node, the flow proceeds to Step S703 where the 802.11g node first sets the value of Duration field in the CTS-to-self frame according to the service payload condition of the network. Then, the 802.11g node transmits at Step S704 the CTS-to-self frame for which the value of Duration field has been set. At Step S705, the 802.11g node updates the timing value of the timer for channel reservation period according to the following equation (2).

New_Counter_Value=Protection_Duration_Value (2)

where Protection_Duration_Value represents the value of Duration field in the CTS-to-self frame set by the 802.11g node. Protection_Duration_Value can be calculated according to the following equation (3).

Protection_Duration_Value=M*(ORI+ABD) (3)

where M represents the number of the 802.11g nodes in the hybrid WLAN, ORI represents the time required for completing the current transmission by each 802.11g node, ABD represents the average Backoff duration of the 802.11g nodes. The value of ABD is represented as (CWₘᵢₙ+CWₘₐₓ)*Time_Slot/2, where Time_Slot denotes the length of a single time slot, CWₘᵢₙ denotes the minimal contention window, and CWₘₐₓ denotes the maximal contention window. It should be noted that above equation (3) is merely an example of setting Protection_Duration_Value, other than limiting the present invention. In various actual applications, the 802.11g node may set the value of Duration field in the CTS-to-self frame in different ways (not limited by the equation (3)), as long as the set value is less than the allowed maximal value of Duration field. Once the 802.11g node updates the timing value of its timer for channel reservation period, the flow proceeds to Step S702 where the 802.11g node transmits the data frame.

According to the method of the present invention, the Duration field in the CTS-to-self frame is set to the larger value. When the remaining time of the timer for channel reservation of an 802.11g node is longer than the time required for transmitting a data frame, the node transmits the data frame immediately, with no need of transmitting a CTS-to-self frame at first. In this way, the overhead for control frames is reduced. With the method of the present invention, the simulation comparison shows that the voice capacity of VoIP can be increased by 100% in the 802.11b/g hybrid WLAN, and the throughput of a 802.11b data terminal may also be increased by 100%.

Compared with the conventional 802.11g standard and its existing improvements, the method and apparatus of the present invention can reduce the overhead for control frames, and thus improve voice service quality in a WLAN. It is possible to expand voice capacity and data-service-related throughput in the network.

The present invention is flexible, robust, easy to implement and backward compatible. Modification is required for only 802.11g nodes in the present invention. In additional, the method of the present invention can be flexibly extended since it imposes no strict requirement on the value of Duration field. As long as the value is not greater than the allowed maximal value of Duration field, the method of the present invention may function normally. The method may be applied to improve quality for any other services, in additional to voice service.

The present invention has been described in connection with the above preferred embodiments. One skilled in the art will appreciate that various change, substitution and addition can be made within the spirit and scope of the present invention. The scope of the present invention is defined by the appended claims, other than limited to the foregoing embodiments.

What is claimed is:

1. A method for reducing control signaling overhead in a hybrid wireless network, comprising:
at a first terminal, receiving a wireless frame in the hybrid wireless network, and determining whether the received wireless frame is a control frame for wireless channel reservation;
if the received wireless frame is a control frame for wireless channel reservation, reading by the first terminal a value of Duration field in control frame, and updating a timer for a channel reservation period in the first terminal with the value of Duration field, instead of updating network allocation vector of the first terminal;
before transmitting a data frame by the first terminal, determining whether the remaining time of the timer for the channel reservation period is longer than the time required for transmitting the data frame or not; and
transmitting the data frame directly by the first terminal without transmission of a control frame for wireless channel reservation if the remaining time is longer than the time required for transmitting the data frame or not.

2. The method according to claim 1, further comprising transmitting a control frame for wireless channel reservation by the first terminal if the remaining time is not longer than the time required for transmitting the data frame.

3. The method according to claim 1, further comprising, when the control frame for wireless channel reservation is received by a second terminal, updating network allocation value of the second terminal with the value of Duration field in the control frame and setting the second terminal into a Backoff state during the time period of the updated network allocation value.

4. The method according to claim 1, wherein upon reception of the control frame for wireless channel reservation, the first terminal updates its timer for channel reservation period according to the following equation:
New_Counter_Value=MAX(Cur_Duration_Value,Cur_Counter_Value)
where New_Counter_Value represents the updated value of the timer for channel reservation period, Cur_Duration_Value represents the value of Duration field of the received control frame, and Cur_Counter_Value represents the current timing value of the timer for channel reservation period.

5. The method according to claim 1, further comprising setting the value of Duration field of a control frame for wireless channel reservation by the first terminal before transmitting the data frame by the first terminal based on service payload condition in the hybrid wireless network.

6. The method according to claim 5, further comprising updating the timing value of the timer for channel reservation period in the first terminal after setting the value of Duration field of a control frame for wireless channel reservation by the first terminal according to the following equation,
New_Counter_Value=Protection_Duration_Value
where Protection_Duration_Value represents the value of Duration field of the control frame for wireless channel reservation set by the first terminal.

7. The method according to claim 6, further comprising calculating Protection_Duration_Value with the following equation,
Protection_Duration_Value=M*(ORI+ABD)
where M represents the number of first terminals in the hybrid wireless network, ORI represents the time required for completing a current transmission by each of the first terminals, ABD represents the average Backoff duration of the first terminals.

8. The method according to claim 6, wherein the ABD value is calculated with the following equation,
(CWₘᵢₙ+CWₘₐₓ)*Time_Slot/2
where Time_Slot represents the length of a single time slot, CWₘᵢₙ represents minimal contention window, and CWₘₐₓ represents maximal contention window.

9. The method according to any one of claims 1-8, wherein the hybrid wireless network comprises an 802.11g standard-compliant wireless local area network (WLAN) and an 802.11b standard-compliant WLAN.

10. The method according to any one of claims 1-8, wherein the first terminal is a terminal device applied in the 802.11g WLAN, and the second terminal is a terminal device applied in the 802.11b WLAN.

11. An apparatus for reducing control signaling overhead in a hybrid wireless network, comprising:
a transmitter to determine the type of a frame to be transmitted, and set a value of Duration field and associated type field according to the type of the frame and the quality condition of service in the wireless network;
a frame type identifying device to determine the type of a received frame;
a wireless channel reservation control frame processing device having a timer for a channel reservation period and to receive the frame type provided from the frame type identifying device to update the timer for channel reservation period, instead of network allocation vector of the transmitter, with the value of Duration field if the received frame is a control frame for a wireless channel reservation; and
a receiver to receive a data frame and a control frame for the wireless channel reservation transmitted by a terminal in the hybrid wireless network, and to update the network allocation vector according to the type of the received frame and the quality condition of service in the wireless network.

12. The apparatus according to claim 11, wherein the transmitter comprises:
a transmitting storage device to store a data packet from a higher layer, determine the type of the data packet and encapsulate the data packet into a data frame;
a channel accessing device to determine whether the apparatus can access a channel and transmit the data frame; and
a transmitting device to transmit the encapsulated data frame.

13. The apparatus according to claim 11, wherein the receiver comprises:
a channel sensing device to sense a channel in the wireless network in the case of no data packet being transmitted by the apparatus, and initiate the receiving device to prepare for data reception when the sensed channel is busy;
a receiving device to receive a data packet from a wireless channel and provide the received data packet to a reception processing device for further determination; and
a reception processing device to determine whether the data packet is received successfully as well as the type of the received data packet.
